(19) United States
(12) Patent Application Publication
(10) Pub. No.: US 2008/0115413 A1
(43) Pub. Date: May 22, 2008

(54) Horticulture tray

(75) Inventor: Fred N. Blackmore, Belleville, MI (US)

Correspondence Address: HARNESS, DICKEY & PIERCE, P.L.C., P.O. BOX 828, BLOOMFIELD HILLS, MI, 48303, US

(73) Assignee: Blackmore Company, Inc.

(21) Appl. No.: 11/602,385

(22) Filed: Nov. 20, 2006

(51) Int. Cl. A01G 9/02; B65D 21/02

(52) U.S. Cl. 47/65.7; 47/87; 206/507; 47/65.5

(57) ABSTRACT

A first horticulture tray including cells and posts axially extending in the same direction from an upper surface. The cells are arranged in rows and columns that are aligned approximately perpendicular to the rows. The cells and the posts nest within similar cells and similar posts of a similar horticulture tray in a first orientation. The posts contact a similar upper surface of the similar horticulture tray to space the upper surface from the similar horticulture tray in a second orientation.

### FIELD

The present disclosure generally relates to horticulture trays and, in particular, to stackable horticulture trays.

### BACKGROUND

The statements in this section merely provide background information related to the present disclosure and may not constitute prior art.

Horticulture trays are often used to transport and store seeds and/or plants. The plants are often present in a growth medium, such as peat moss wrapped in biodegradable paper, and seated within recesses of the horticulture trays. The recesses are often not linearly aligned with each other, thus making it difficult to load and/or unload the plants from within the recesses using an automated procedure. Also, such trays are often not provided with features for suitably stacking multiple trays on top of each other without compacting the plants in the lower tray. Further, such trays are often not provided with suitable features that will permit the trays to be nested within each other to decrease the area that the stacked trays occupy when the trays are not carrying plants.

While conventional horticulture trays are suitable for their intended uses, they are subject to improvement.

### SUMMARY

The present teachings provide for a first horticulture tray including cells and posts axially extending in the same direction from an upper surface. The cells are arranged in rows and columns that are aligned approximately perpendicular to the rows. The cells and the posts nest within similar cells and similar posts of a similar horticulture tray in a first orientation. The posts contact a similar upper surface of the similar horticulture tray to space the upper surface from the similar horticulture tray in a second orientation.

The present teachings further provide for a horticulture tray stacking system including a first tray and a second tray. The first tray includes cells and posts axially extending in the same direction from an upper surface. The cells are arranged in rows and columns that are aligned approximately perpendicular to the rows. The second tray includes cells and posts axially extending in the same direction from an upper surface. The cells are arranged in rows and columns that are aligned approximately perpendicular to the rows. The cells and the posts of the first tray are nested within the cells and the posts of the second tray in a first orientation. The posts of the first tray contact the upper surface of the second tray and the upper surface of the first tray is spaced apart from the upper surface of the second tray in a second orientation.

The present teachings still further provide for a method including separating adjacent upper surfaces of a first tray and a second tray by displacing cells and posts of the first tray nested within cells and posts of the second tray; inserting horticultural items into the cells of the first and second trays; and stacking the first tray relative to the second tray by contacting the posts of the first tray with the upper surface of the second tray.

Further areas of applicability will become apparent from the description provided herein. It should be understood that the description and specific examples are intended for purposes of illustration only and are not intended to limit the scope of the present claims.

### DRAWINGS

The drawings described herein are for illustration purposes only and are not intended to limit the scope of the present disclosure in any way.

FIG. 1 is a top plan view of a first horticulture tray according to the present teachings;

FIG. 2 is a perspective view of a lower surface of the first horticulture tray;

FIG. 3 is a cross-sectional view taken along line 3-3 of FIG. 2;

FIG. 4 is a perspective view of the lower surface of the first horticulture tray and an upper surface of a second horticulture tray, the first and second horticulture trays are arranged in a first orientation relative to each other in which cells and support posts of the first tray can be nested within cells and support posts of the second tray when the first tray is stacked on top of the second tray;

FIG. 5 is a partial cross-sectional view of the first tray stacked on top of the second tray in the first orientation illustrating two cells of the first tray nested within two cells of the second tray and a post of the first tray nested within a post receptacle of the second tray;

FIG. 6 is a perspective view of the lower surface of the first tray and the upper surface of the second tray, the first and second trays are arranged in a second orientation in which one of the first and second trays is rotated 180 degrees from the first orientation such that the posts of the first tray contact the upper surface of the second tray to support the cells of the first tray over the cells of the second tray when the first tray is stacked on top of the second tray;

FIG. 7 is a partial cross-sectional view of the first tray stacked on top of the second tray in the second orientation illustrating two cells of the first tray suspended over two cells of the second tray and the post of the first tray in contact with an upper surface of the second tray;

FIG. 8 is a perspective view of the lower surface of the first tray and the upper surface of the second tray, the first and second trays are arranged in a third orientation in which one of the first and second trays is rotated 90 degrees from the first orientation such that posts of the first tray contact the upper surface of the second tray to support the cells of the first tray over cells of the second tray when the first tray is stacked on top of the second tray; and

FIG. 9 is a plan view of an upper surface of another horticulture tray according to present teachings.

### DETAILED DESCRIPTION

The following description is merely exemplary in nature and is in no way intended to limit the present disclosure, application, or uses. Throughout this specification, like reference numerals will be used to refer to like elements.

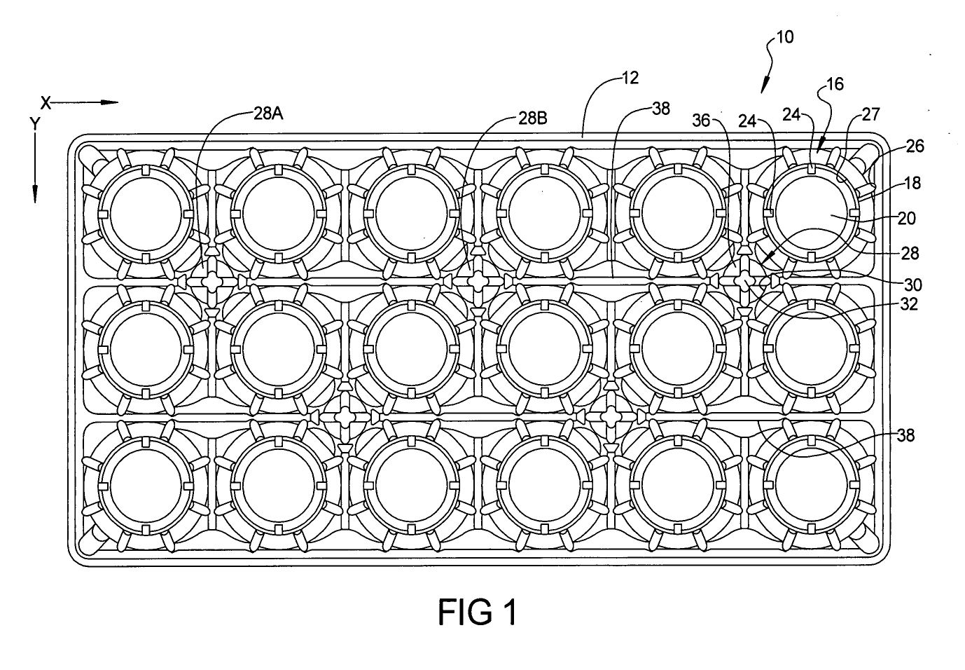

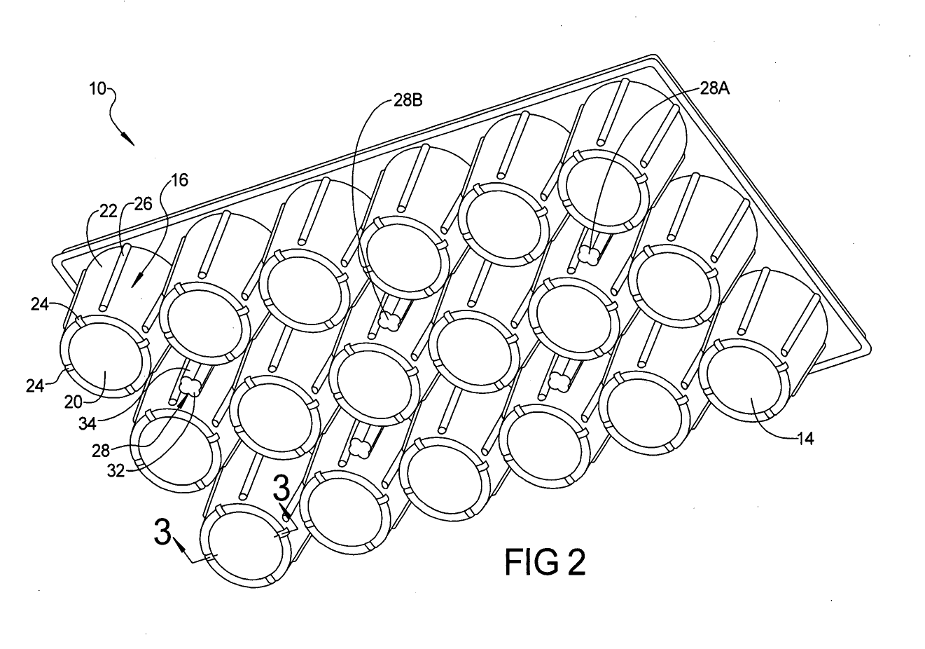

With initial reference to FIGS. 1 and 2, a first horticulture tray of the present teachings is illustrated at reference numeral 10. While the tray 10 is described herein as a horticulture tray, the tray 10 is not limited to horticulture applications. The tray 10 can be used to transport or store any suitable, item, material, or device.

The tray 10 can include an upper surface 12 (FIG. 1) and a lower surface 14 (FIG. 2) that is opposite to the upper surface 12. The upper surface 12 and the lower surface 14 can extend in generally parallel planes.

The tray 10 can include a plurality of cells 16. The cells 16 can extend from the upper surface 12 to the lower surface 14. Each cell 16 can be at least substantially the same. For example, each cell 16 can include an opening 18 that can be at or proximate to the upper surface 12 and a base 20 that can be at or proximate to the lower surface 14. A sidewall 22 can extend between the upper surface 12 and the lower surface 14.

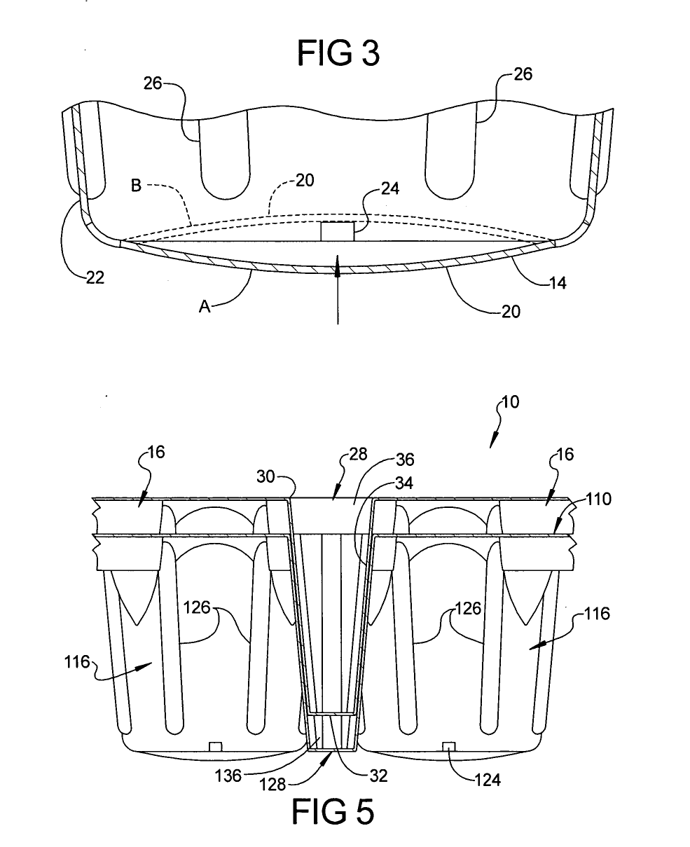

The base 20 can be a flexible base. For example and with additional reference to FIG. 3, the base 20 can move between a first position A and a second position B. The base 20 can be made of any suitable flexible material, such as polystyrene or polypropylene, to permit movement between positions A and B. The base 20 can typically be positioned at position A when a material is seated within the cell 16. Moving the base 20 to position B, by depressing the base 20 at the lower surface 14, can facilitate removal of materials from within the cell 16.

The base 20 can further include one or more through holes 24. The through holes 24 can be any suitable size, shape, or configuration to permit the passage of water and other materials from within the cell 16.

The sidewall 22 can extend from the base 20 to the cell opening 18. The sidewall 22 can extend at least proximate to the upper surface 12 to prevent migration of materials, or in the case of horticulture applications roots, between adjoining cells 16. The sidewall 22 can be substantially circular. The sidewall 22 can be tapered so that the diameter of the cell 16 is larger at the cell opening 18 than at the cell base 20. The sidewall 22 can include one or more reinforcement features, such as reinforcement ribs 26. The ribs 26 can be molded with the sidewall 22. The sidewall 22, along with the cell opening 18 and the base 20, can define a receptacle 27 in which plants or any other device or material to be stored or transported using the tray 10 can be seated and contained.

The cells 16 can be arranged in a plurality of columns and rows. With reference to FIG. 1, the columns can extend in direction “Y” and the rows can extend in direction “X”. The cells 16 in each row X and column Y can be linearly arranged such that each cell 16 is in vertical or horizontal alignment with the neighboring cell 16. Arranging the cells 16 in horizontal and vertical alignment with each other can facilitate the automated loading of materials, such as plants, within the cells 16 by machine.

While the tray 10 can include any suitable number of cells 16, the cells 16 can be present in a 2:1 ratio such that each row X has 2 cells 16 for every one cell 16 of column Y. For example and as illustrated in FIG. 1, the tray 10 can have six cells 16 per row X and three cells 16 per column Y and can have a total of 18 cells. In addition to the configuration illustrated, the tray 10 can include any other suitable number of cells 16 or arrangement of cells 16.

The tray 10 can further include at least one support post 28. Each support post 28 can be substantially similar or identical. Each support post 28 can include a support post opening 30, a base 32, and sidewalls 34. The support posts 28 can axially extend in the same direction from the upper surface 12 as the cells 16 do.

The opening 30 can be at the upper surface 12 of the tray 10 or recessed beneath the upper surface 12. The base 32 can be at or proximate to the lower surface 14 and the bases 20 of the cells 16. The sidewalls 34 can extend between the post opening 30 and the post base 32. The sidewalls 34 can be tapered such that the diameter of the post 28 proximate to the base 32 is smaller than the diameter of the post 28 proximate to the opening 30. The sidewalls 34 and the post base 32 can define a post receptacle 36. Access to the post receptacle 36 can be provided at the post opening 30. The post receptacle 36 can be of any suitable shape or size to, as described below, receive a similarly configured post from a tray that is at least substantially identical to the tray 10.

The posts 28 can be positioned between the cells 16. For example, the posts 28 can be positioned between four different cells 16, as illustrated in FIGS. 1 and 2. Further, the posts 28 can be arranged such that posts 28 in the same row X, such as posts 28A and 28B, are not in neighboring columns Y. The posts 28 can also be positioned such that, as further described below, when the first tray 10 is stacked on a second tray that is at least substantially identical to the first tray and rotated 180 degrees relative to the second tray, the posts 28 of the different trays are not vertically aligned.

The tray 10 can also include at least one support platform or rib 38. The rib 38 can be generally planar with the upper surface 12. The rib 38 can be of a sufficient shape and size to support, as further described below, one of the posts 28 of a second tray that is at least substantially the same as the first tray 10. The support rib 38 can be unitary with the remainder of the tray 10, such as molded with the tray 10. The support rib 38 can be an extension of the cell sidewalls 22 or can be independent of the sidewalls 22. The rib 38 can have a width at the upper surface 12 that is wider than the width of the sidewalls 22 at the upper surface 12.

The support ribs 38 can be positioned at least proximate a point between four different cells 16 where the posts 28 are not provided, as illustrated in FIG. 1. The support ribs 38 can also be positioned such that, as further described below, when a second tray that is at least substantially identical to the first tray 10 is stacked on the first tray 10 and rotated 180 degrees relative to the first tray 10, post bases of the second tray can contact the support ribs 38 of the first tray 10 to support the second tray on top of the first tray 10.

The first tray 10 can be made of any suitable material and can be manufactured using any suitable manufacturing method. For example, the tray 10 can be made of polystyrene or polypropylene. An exemplary manufacturing technique can include a thermoforming process.

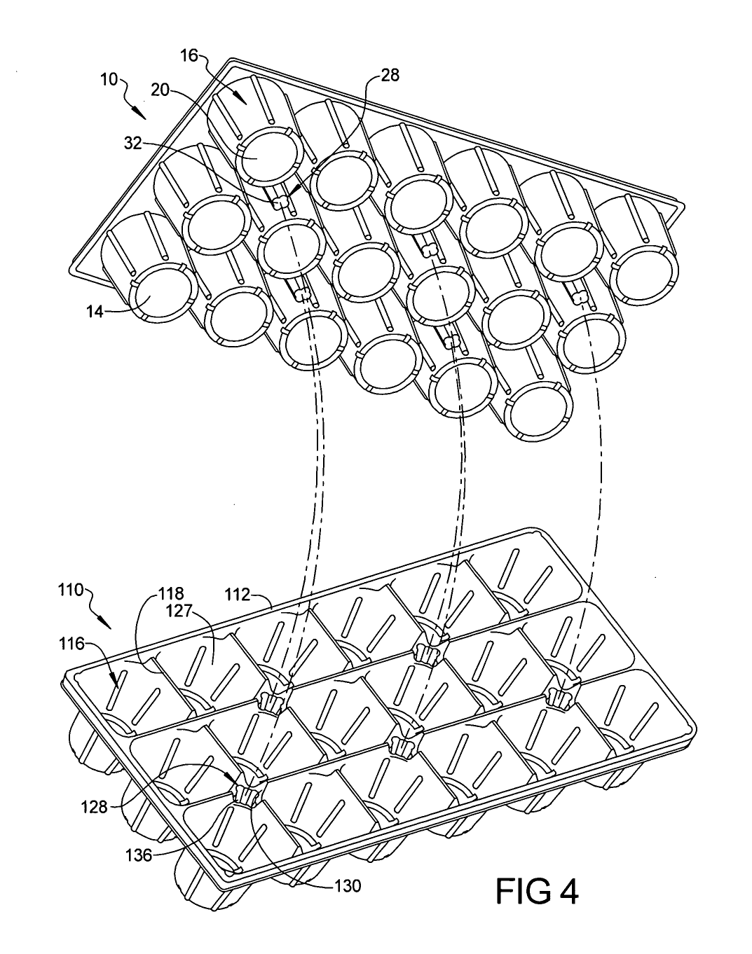

With additional reference to FIGS. 4 and 5, a second tray is illustrated at reference numeral 110. The second tray 110 can be at least substantially similar to the first tray 10. Features of the second tray 110 that are at least substantially similar to features of the first tray 10 are illustrated with the same reference numbers used to describe the first tray 10, but increased by 100. The above description of the first tray 10 equally applies to the second tray 110.

The first tray 10 and the second tray 110 can be stacked on top of each other as part of a tray stacking system. Specifically, the first tray 10 and the second tray 110 can be positioned at a first orientation relative to each other, as illustrated in FIG. 4, such that each of the support posts 28 of the first tray 10 are vertically aligned with the support posts 128 of the second tray 110. With the first tray 10 and the second tray 110 positioned in the first orientation, the posts 28 of the first tray 10 can be seated within the support post receptacles 136 of the posts 128 of the second tray 110, as illustrated in FIG. 5. Further, the cells 16 of the first tray 10 can be seated within the cell receptacles 127 of the second tray 110. Stacking the first tray 10 and the second tray 110 in this manner reduces the overall height of the stacked trays to reduce the overall area and/or volume that the first and second trays 10 and 110 occupy. Thus, stacking the first and second trays 10 and 110 in this manner is useful for a number of purposes, such as transporting or storing the trays 10 and 110 in a confined space when the cells of the trays, at least the cells 116 of the second tray 110, are empty.

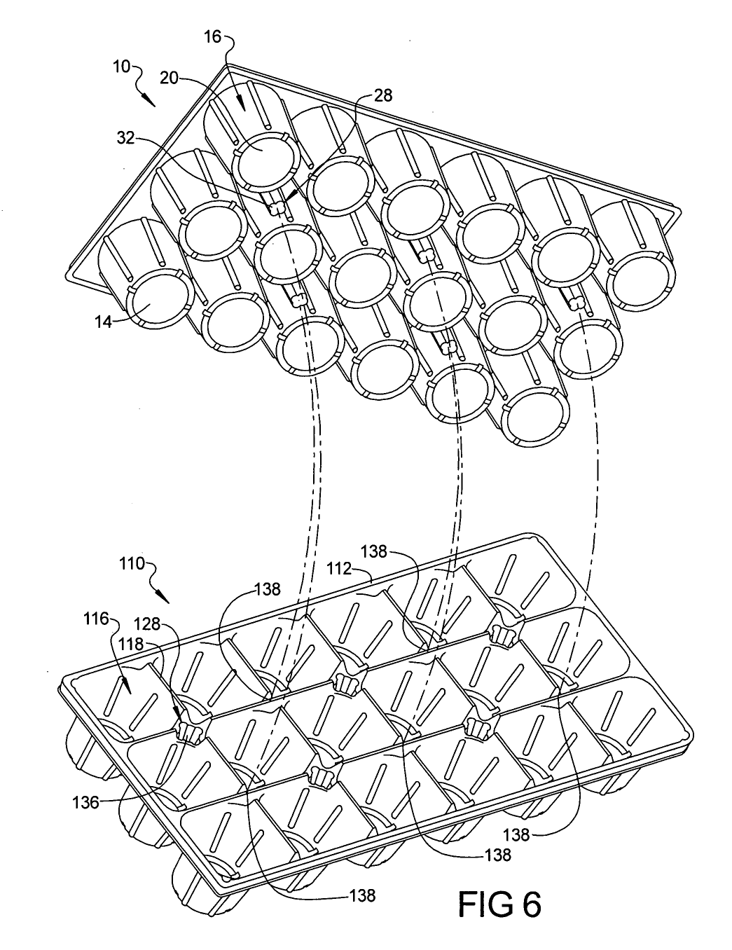

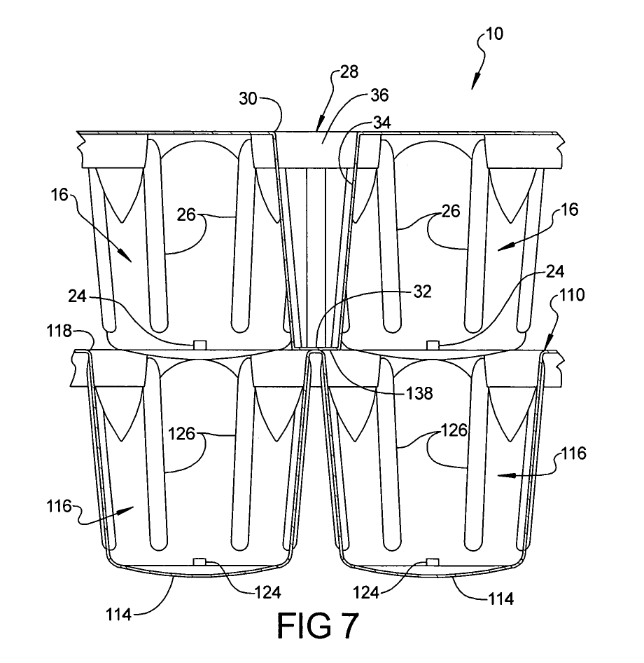

With additional reference to FIGS. 6 and 7, the first and second trays 10 and 110 can be positioned at a second orientation relative to each other in which one of the first tray 10 and the second tray 110 is rotated 180 degrees relative to the other tray 10 and 110. In the second orientation, the first tray 10 and the second tray 110 can be positioned such that the support posts 28 of the first tray 10 are vertically aligned with the support ribs 138 of the second tray 110 and the cells 16 of the first tray 10 are axially aligned with the cells 116 of the second tray 110. With the first and second trays 10 and 110 positioned at the second orientation of FIG. 6, when the lower surface 14 of the first tray 10 is seated on the upper surface 112 of the second tray 110 the post bases 32 of the support posts 28 contact the support ribs 138 of the second tray 110. The contact between the post bases 32 and the support ribs 138 supports the first tray 10 on top of the second tray 110 and supports the cells 16 of the first tray 10 at least substantially over, and in axial alignment with, the cells 116 of the second tray 110, as illustrated in FIG. 7.

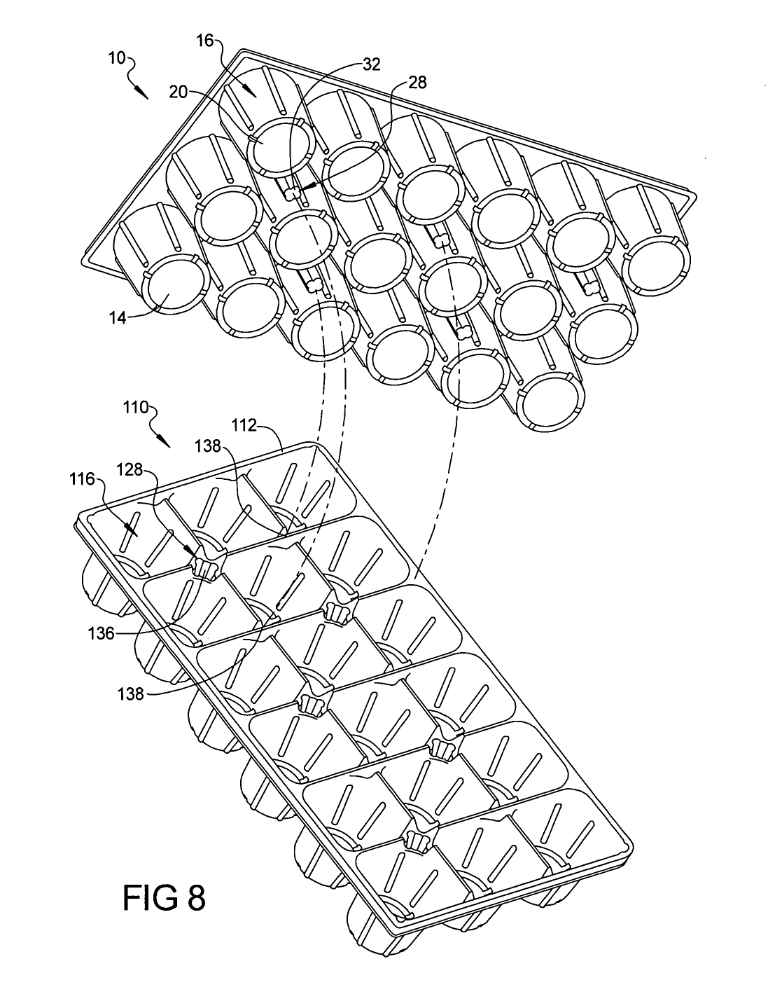

With additional reference to FIG. 8, the first tray 10 and the second tray 110 can be positioned at a third orientation relative to each other in which one of the first tray 10 and the second tray 110 is rotated 90 degrees relative to the other tray 10 and 110. The third orientation is similar to the second orientation in that the first tray 10 and the second tray 110 are positioned such that a number of the support posts 28 of the first tray 10 are vertically aligned with a number of the support ribs 138 of the second tray 110. When the lower surface 14 of the first tray 10 is seated on the upper surface 112 of the second tray 110 the post bases 32 of the support posts 28 contact the support ribs 138 of the second tray 110. The contact between the post bases 32 and the support ribs 138 supports the first tray 10 on top of the second tray 110 and supports at least a substantial portion of each of the cells 16 of the first tray 10 over the cells 116 of the second tray 110. By comparison, in the second orientation the first and second trays 10 and 110 completely overlap, while in the third orientation the first and second trays do not completely overlap. In the third orientation the first tray 10 can overlap one half of the second tray 110. If an additional tray is provided, which is generally similar to the first and second trays 10 and 110, the additional tray can be positioned parallel to the second tray 110 and the portion of the first tray 10 not seated on the second tray 110 can be seated on top of the additional tray.

Stacking the first and second trays 10 and 110 with the trays orientated in the second and third orientations is useful for a variety of different purposes. For example, stacking the trays 10 and 110 in this manner may prevent compaction of plants or other items seated within the cells 116 of the second tray 110 by the cells 16 of the first tray 10, while at the same time facilitating storage or transportation of the plants or other items seated within the cells 16 and 116.

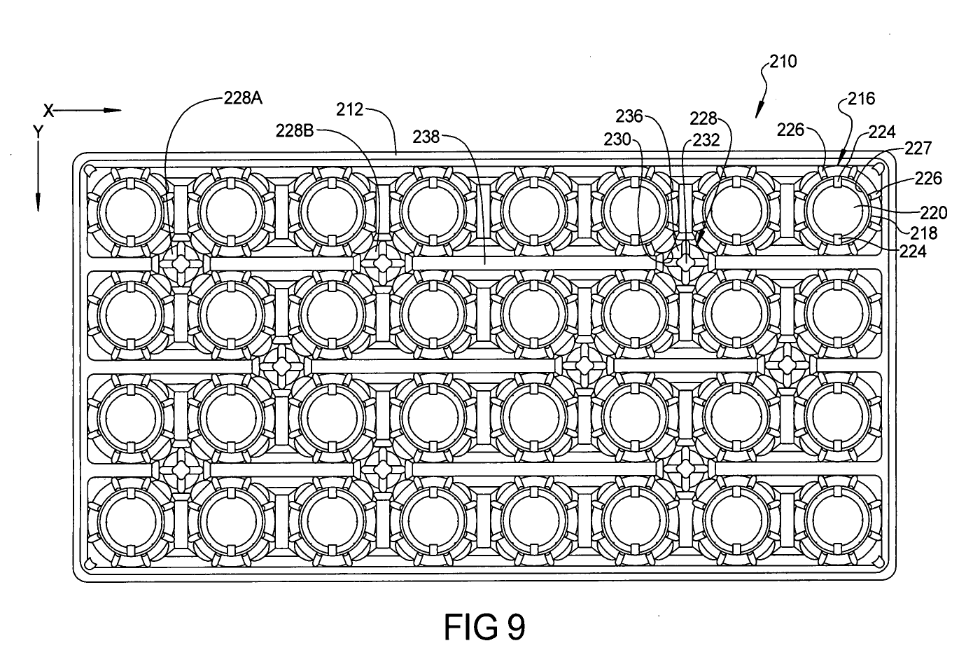

With reference to FIG. 9, another first tray in accordance with the present teachings is illustrated at reference numeral 210. The tray 210 can be at least substantially similar to the first tray 10. Features of the tray 210 that are at least substantially similar to features of the first tray 10 are illustrated with the same reference numbers used to describe the first tray 10, but increased by 200. The above description of the features of the tray 10 can equally apply to the like features of the tray 210. The tray 210 differs from the first tray 10 in the number of, and position of, the cells 216 and the support posts 228 as compared to the cells 16 and the support posts 28 of the first tray 10.

The cells 216 of the tray 210 can be present in a 2:1 ratio such that each row X has two cells 216 for every cell 216 of column Y. For example and as illustrated in FIG. 9, the tray 210 can have eight cells 216 per row X and four cells 216 per column Y. In addition to the configuration illustrated, the tray 210 can include any other suitable number of cells 216 or arrangement of cells 216.

The support posts 228 can be positioned between the cells 216. For example, the posts 228 can be positioned approximate a point between four different cells 216, as illustrated in FIG. 9. Further, the posts 228 can be positioned such that posts 228 in the same row X, such as posts 228A and 228B, are not in neighboring columns Y. The posts 228 can also be positioned such that when the tray 210 is stacked on top of another second tray that is at least substantially identical to the tray 210 and rotated 90 degrees or 180 degrees relative to the tray 210, the post bases 232 of the posts 228 can be seated on a support rib at the upper surface 212 of the additional second tray to support the additional first tray 210 on top of the additional second tray.

What is claimed is:

1. For use with a similar horticultural tray, a first horticulture tray comprising cells and posts axially extending in the same direction from an upper surface, said cells arranged in rows of said cells aligned approximately perpendicular to columns of said cells, said cells and said posts nesting within similar cells and similar posts of a similar horticulture tray in a first orientation, and said posts contacting a similar upper surface of the similar horticulture tray to space said upper surface from the similar horticulture tray in a second orientation.

2. The first horticulture tray of claim 1, wherein in the second orientation said first tray is positioned 90 degrees relative to the similar tray.

3. The first horticulture tray of claim 1, wherein in the second orientation said first tray is positioned 180 degrees relative to the similar tray.

4. The first horticulture tray of claim 1, where said cells and said posts extend approximately the same distance from said upper surface.

5. The first horticulture tray of claim 1, wherein said first tray is comprised of at least one of polystyrene and polypropylene.

6. The first horticulture tray of claim 1, wherein said cells include a base that is flexible between a first position and a second position.

7. The first horticulture tray of claim 1, wherein said cells of said first tray are axially aligned with the similar cells of the similar tray in the second orientation.

8. The first horticulture tray of claim 1, wherein said cells of said first tray include a base having a through hole.

9. The first horticulture tray of claim 1, wherein each of said rows of said cells include two of said cells for every one of said cells provided in each of said columns of said cells.

10. The first horticulture tray of claim 1, wherein said first tray comprises eighteen of said cells.

11. The first horticulture tray of claim 1, wherein said first tray comprises thirty-two of said cells.

12. A horticulture tray stacking system comprising:
a first tray including cells and posts axially extending in the same direction from an upper surface, said cells arranged in rows of said cells that are aligned approximately perpendicular to columns of said cells; and
a second tray including cells and posts axially extending in the same direction from an upper surface, said cells arranged in rows of said cells that are aligned approximately perpendicular to columns of said cells;
said cells and said posts of said first tray nesting within said cells and said posts of said second tray in a first orientation; and
said posts of said first tray contacting said upper surface of said second tray and said upper surface of said first tray spaced apart from said upper surface of said second tray in a second orientation.

13. The horticulture tray stacking system of claim 12, wherein said cells of said first tray axially align with said cells of said second tray in said second orientation.

14. The horticulture tray stacking system of claim 12, wherein in the second orientation said first tray is positioned 90 degrees relative to said second tray.

15. The horticulture tray stacking system of claim 12, wherein in the second orientation said first tray is positioned 180 degrees relative to said second tray.

16. The horticulture tray stacking system of claim 12, wherein said posts of said first tray contact support ribs at said upper surface of said second tray in said second orientation.

17. The horticulture tray stacking system of claim 12, wherein said cells include a base that is flexible between a first position and a second position.

18. The horticulture tray stacking system of claim 12, wherein each of said plurality of rows of said cells of said first tray include twice as many of said cells as each of said plurality of columns of said cells of said first tray.

19. The horticulture tray stacking system of claim 12, wherein said posts are located between four of said cells.

20. A method comprising:
separating adjacent upper surfaces of a first tray and a second tray by displacing cells and posts of said first tray nesting within cells and posts of said second tray;
inserting horticultural items into said cells of said first and second trays; and
stacking said first tray relative to said second tray by contacting said posts of said first tray with said upper surface of said second tray.

21. The method of claim 20, wherein said stacking includes orienting said first tray at a 90 degree angle relative to said second tray.

22. The method of claim 20, wherein said stacking includes orienting said first tray at a 180 degree angle relative to said second tray.

23. The method of claim 20, wherein said stacking includes orienting said first tray relative to said second tray such that said cells of said first tray are axially aligned with said cells of said second tray.
